(19) United States
(12) Patent Application Publication
(10) Pub. No.: US 2015/0000340 A1
(43) Pub. Date: Jan. 1, 2015

(54) APPARATUS FOR FORMING A GLASS

(71) Applicant: SAMSUNG DISPLAY CO., LTD., YONGIN-CITY (KR)

(72) Inventors: Jin-Seok Jang, Asan-si (KR); Jong-Hwan Kim, Seoul (KR); Kwan-Young Han, Seongnam-si (KR); Seong-Jin Hwang, Suwon-si (KR); Jae-Seung Jeon, Cheonan-si (KR); Dae-Sik Hong, Cheonan-si (KR)

(73) Assignee: SAMSUNG DISPLAY CO., LTD., YONGIN-CITY (KR)

(21) Appl. No.: 14/218,932

(22) Filed: Mar. 18, 2014

(30) Foreign Application Priority Data
Jun. 28, 2013 (KR) 10-2013-0075114

(51) Int. Cl. C03B 23/03

(52) U.S. Cl. CPC C03B 23/0302
USPC 65/106; 65/291

(57) ABSTRACT

An apparatus for forming a glass, the apparatus including a lower mold, a fixing mold and an upper mold is disclosed. The lower mold may be configured to support a central portion of a lower surface of the glass. The fixing mold may be configured to support a central portion of an upper surface of the glass. The upper mold may press two edge portions of the upper surface of the glass to form rounded portions at the two edge portions of the glass. An apparatus for forming a glass, the apparatus including: a lower mold configured to press two edge portions of a lower surface of the glass to form rounded portions at the two edge portions of the glass; a fixing mold configured to support a central portion of the lower surface of the glass; and an upper mold configured to support a central portion of an upper surface of the glass is also disclosed.

### CROSS-REFERENCE TO RELATED APPLICATION

This application claims priority to and the benefit of Korean Patent Application No. 10-2013-0075114, filed on Jun. 28, 2013 in the Korean Intellectual Property Office (KIPO), the entire content of which is incorporated herein by reference.

### BACKGROUND

1. Field

Aspects according to embodiments of the present disclosure relate to an apparatus for forming a glass. More particularly, aspects according to embodiments of the present disclosure relate to an apparatus for forming a glass of a portable or mobile telephone (e.g., a cellular telephone).

2. Description of Related Art

Generally, a glass for a portable or mobile telephone (e.g., a cellular telephone) may include two edges having a rounded shape. For example, the two edges of the glass may be bent using a forming apparatus.

The two edges of the glass may be bent (or formed) using a mold having a rounded portion corresponding to the rounded shape of the two edges of the glass. Therefore, the two edges of the glass may be formed through contact with an entire surface of the rounded portion of the mold.

However, the glass may be heated before the forming process of forming the rounded edges of the glass, and the glass may bend due to a self-load of the glass (e.g., the glass may undesirably bend under its own weight). When the forming process is performed on bent glass, the rounded edges of the resultant glass may not have the desired shape.

### SUMMARY

Aspects according to embodiments of the present disclosure are directed to an apparatus for forming a glass that may be capable of preventing damage to the glass (or reducing the likelihood of damage to the glass).

According to example embodiments of the present disclosure, there may be provided an apparatus for forming a glass. The apparatus may include a lower mold, a fixing mold and an upper mold. The lower mold may be configured to support a central portion of a lower surface of the glass. The fixing mold may be configured to support a central portion of an upper surface of the glass. The upper mold may press two edge portions of the upper surface of the glass to form rounded portions at the two edge portions of the glass.

In example embodiments, the lower mold may include a lower block and a supporting portion on an upper surface of the lower block, the supporting portion being configured to support the central portion of the lower surface of the glass.

In example embodiments, the supporting portion may have a forming portion at upper ends of two side surfaces of the supporting portion. The forming portion may have a curvature corresponding to a curvature of the rounded portion to be formed in the glass.

In example embodiments, the lower mold may further include a guiding portion on an upper surface of the lower block at two sides of the supporting portion, the guiding portion being configured to guide the two edge portions of the glass.

In example embodiments, the upper mold may include an upper block, and pressing portions on a lower surface of the upper block to press the two edge portions of the glass.

In example embodiments, the apparatus may further include a spring resiliently connected between the fixing mold and the upper mold.

According to example embodiments, there may be provided an apparatus for forming a glass. The apparatus may include a lower mold, a fixing mold and an upper mold. The lower mold may press two edge portions of a lower surface of the glass to form a rounded portion at the two edge portions of the glass. The fixing mold may be configured to support a central portion of the lower surface of the glass. The upper mold may be configured to support a central portion of an upper surface of the glass.

In example embodiments, the lower mold may include a lower block, and pressing portions on an upper surface of the lower block to press the two edge portions of the lower surface of the glass.

In example embodiments, the upper mold may include an upper block, and a supporting portion on a lower surface of the upper block, the supporting portion being configured to support the central portion of the upper surface of the glass.

In example embodiments, the supporting portion may have a forming portion at lower ends of two side surfaces of the supporting portion. The forming portion may have a curvature corresponding to a curvature of the rounded portion to be formed in the glass.

In example embodiments, the upper mold may further include a guiding portion on a lower surface of the upper block at two sides of the supporting portion, the guiding portion being configured to guide the two edge portions of the glass.

In example embodiments, the apparatus may further include a spring resiliently connected between the fixing mold and the lower mold.

According to example embodiments, a method of forming a glass includes: fixing the glass to a first mold; fixing a fixing mold to the glass; and pressing two edge portions of the glass with a second mold to form rounded portions at the two edge portions of the glass.

In example embodiments, the first mold is a lower mold, the fixing of the glass to the first mold includes placing the glass on the lower mold, the fixing of the fixing mold to the glass includes placing the fixing mold on a central portion of an upper surface of the glass, the second mold is an upper mold, and the pressing of the two edge portions of the glass includes pressing the upper surface of the two edge portions of the glass.

In example embodiments, the first mold is an upper mold, the fixing of the fixing mold to the glass includes placing the glass on an upper surface of the fixing mold, the second mold is a lower mold, and the pressing of the two edge portions of the glass includes pressing a lower surface of the two edge portions of the glass.

According to example embodiments, the fixing mold may firmly support the glass so that the glass may not be deflected. The rounded portion having a desired shape may be formed at the two edge portions of the glass.

### BRIEF DESCRIPTION OF THE DRAWINGS

Example embodiments of the present disclosure will be more clearly understood from the following detailed description taken in conjunction with the accompanying drawings, which serve to explain principles of the present disclosure. FIGS. 1 to 10 represent non-limiting embodiments as described herein.

FIG. 1 is a cross-sectional view of an apparatus for forming a glass in accordance with example embodiments;

FIGS. 2 to 4 are cross-sectional views illustrating a process of forming the glass using the apparatus of FIG. 1;

FIG. 5 is a cross-sectional view of an apparatus for forming a glass in accordance with example embodiments;

FIG. 6 is a cross-sectional view of an apparatus for forming a glass in accordance with example embodiments;

FIGS. 7 to 9 are cross-sectional views illustrating a process for forming the glass using the apparatus of FIG. 6; and

FIG. 10 is a cross-sectional view of an apparatus for forming a glass in accordance with example embodiments.

### DETAILED DESCRIPTION

Various embodiments of the present disclosure will be described more fully hereinafter with reference to the accompanying drawings, in which some embodiments are shown, by way of illustration. The invention may, however, be embodied in many different forms and should not be construed as being limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer, or it can be indirectly on, connected to or coupled to the other element or layer with one or more intervening elements or layers interposed therebetween. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by the terms first, second, third and the like. These terms are only used to distinguish one element, component, region, layer or section from another element, component, region, layer or section. Thus, a first element, component, region, layer or section discussed below could be a second element, component, region, layer or section without departing from the teachings of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (for example, rotated 90 degrees or at other orientations) and the spatially relative descriptors used herein interpreted accordingly.

The terminology used herein is for the purpose of describing the embodiments presented herein only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, components, and/or groups, but do not preclude the presence or addition of one or more other features, integers, steps, operations, elements, components, and/or groups thereof.

Embodiments of the present disclosure are described herein with reference to drawings that include cross-sectional views that are schematic illustrations of idealized embodiments (and intermediate structures). As such, variations from the shapes illustrated in the drawings as a result of, for example, variations in manufacturing techniques and/or tolerances, are to be expected. Thus, the embodiments described herein should not be construed as being limited to the particular shapes of regions of the embodiments illustrated herein, but, on the contrary, are to include deviations in shapes that result from, for example, the effects of manufacturing. Indeed, the regions of the embodiments illustrated in the figures are schematic in nature and their shapes may not illustrate the actual shape of a region of a device and are not intended to limit the scope of the invention.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a cross-sectional view illustrating an apparatus for forming a glass in accordance with example embodiments of the present disclosure.

Referring to FIG. 1, an apparatus 100 for forming a glass in accordance with this example embodiment may include a lower mold 110, a fixing mold 120 and an upper mold 130.

The lower mold 110 may be configured to support a lower surface of a glass G. In example embodiments, the lower mold 110 may include a lower block 112, a supporting portion 114 and a pair of guiding portions 116. The supporting portion 114 may be on a central portion (e.g., an inner or interior portion) of an upper surface of the lower block 112 to support a central portion (e.g., an inner or interior portion) of the lower surface of the glass G. The guiding portions 116 may be on (e.g., may vertically extend from) an upper surface of the lower block 112 at two sides of the supporting portion 114 to guide two edge portions of the glass G.

In example embodiments, the lower mold 110 may include a forming portion 115 at upper ends of two side surfaces of the supporting portion 114. The forming portion 115 may make contact with (e.g., physically contact) the two edge portions of the glass G when the glass G is downwardly pressed by the upper mold 130 to form downwardly rounded portions at the two edge portions of the glass G. For example, the forming portion 115 may have a curvature corresponding to a curvature formed at the downwardly rounded portion of the glass G. In some embodiments, the curvature of the forming portion 115 is determined (or set) in accordance with a design curvature of the downwardly rounded portion of the glass G (e.g., a desired curvature to be formed in the glass G).

The fixing mold 120 may be configured to support a central portion (e.g., an inner or interior portion) of an upper surface of the glass G. The fixing mold 120 may be arranged over the supporting portion 114 of the lower mold 110. The fixing mold 120 may support (e.g., firmly support) the central portion of the glass G, together with the supporting portion 114 of the lower mold 110, to prevent deflection of the glass G (or reduce deflection of the glass G). In example embodiments, the fixing mold 120 may have an area that is substantially the same as that of the supporting portion 114.

In example embodiments, the fixing mold 120 may not be connected to the upper mold 130 (e.g., the fixing mold 120 and the upper mold 130 may be separate or disconnected from one another). Alternatively, the fixing mold 120 may be connected to the upper mold 130.

The upper mold 130 may press the two edge portions of the upper surface of the glass G to form the downwardly rounded portions at the two edge portions of the glass G. In example embodiments, the upper mold 130 may include an upper block 132 and a pair of pressing portions 134.

The pressing portions 134 may be on (e.g., may vertically extend from) a lower surface of the upper block 132. Each pressing portion 134 may be positioned (or located) between the fixing block 120 and the guiding portions 116. The pressing portions 134 may downwardly press the two edge portions of the upper surface of the glass G, which horizontally protrude from the fixing mold 120, to form the downwardly rounded portions at the two edge portions of the glass G.

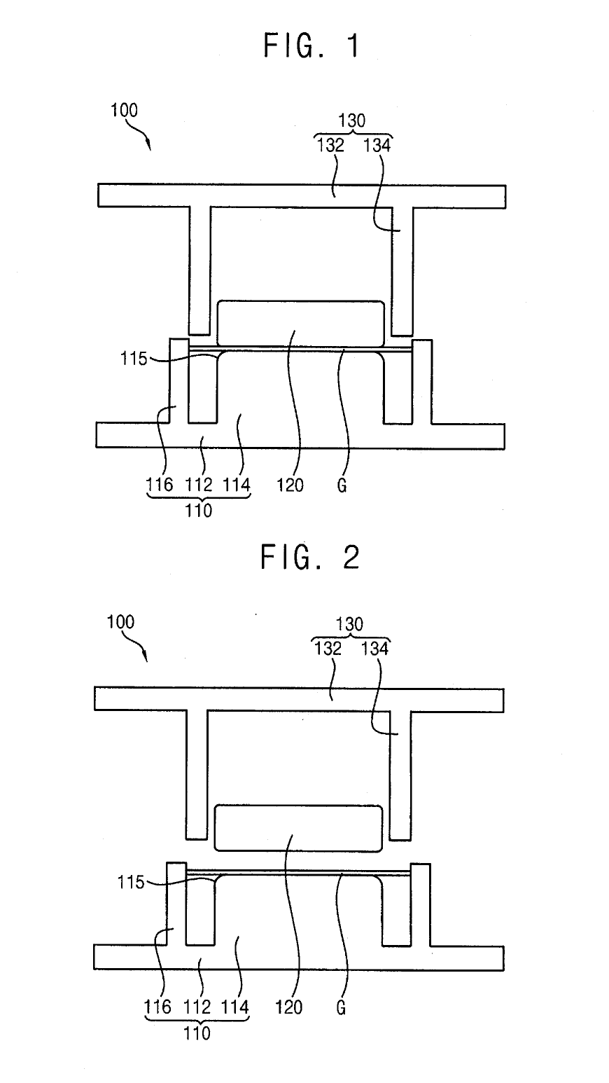

FIGS. 2 to 4 are cross-sectional views illustrating a process of forming the glass using the apparatus in FIG. 1.

Referring to FIG. 2, in a high temperature chamber, the glass G may be placed on the upper surface of the supporting portion 114 of the lower mold 110. The two edge portions of the glass G may protrude from the two side surfaces of the supporting portion 114.

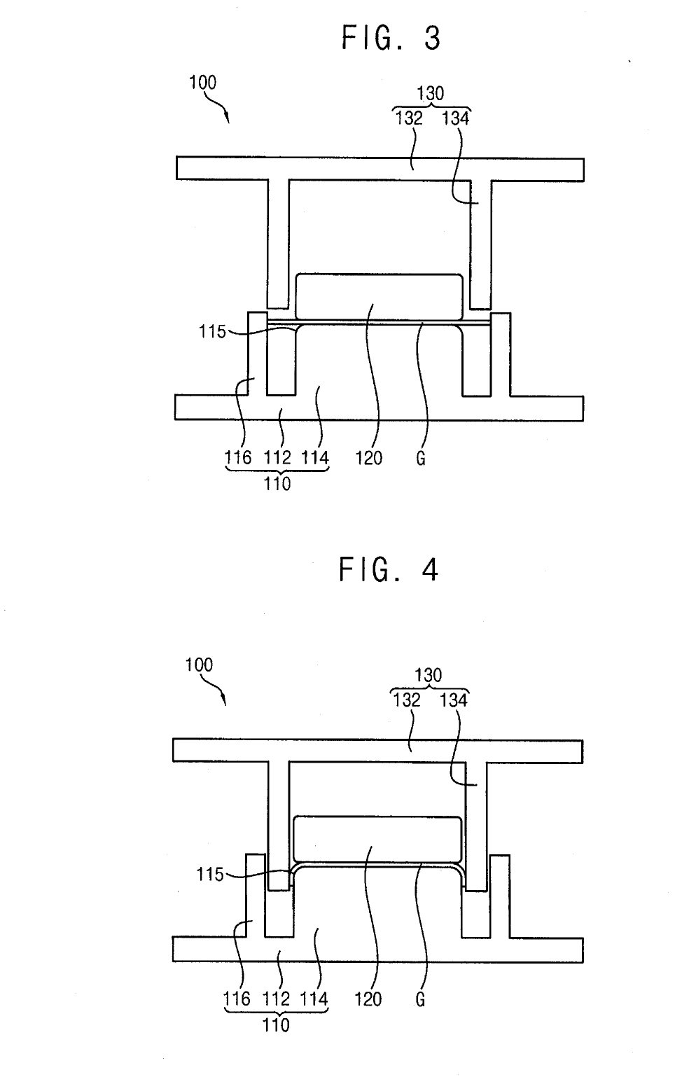

Referring to FIG. 3, the fixing mold 120 may be descended toward the glass G to fix the central portion of the upper surface of the glass G using the fixing mold 120. In example embodiments, because the fixing mold 120 and the supporting portion 114 may fix (e.g., firmly fix) the central portion of the glass G, the glass G may not undesirably bend or deflect due to the high temperature prior to the glass G being pressed by the pressing portions 134 (or the amount of undesirable bending or deflecting of the glass G prior to the glass G being pressed by the pressing portions 134 may be reduced). Further, the area of the fixing mold 120 may be substantially the same as that of the supporting portion 114 so that the two edge portions of the glass G may protrude from the two side surfaces of the supporting portion 114 and two side surfaces of the fixing mold 120.

The upper mold 130 may be descended toward the glass G to contact the pressing portions 134 with the two edge portions of the upper surface of the glass G.

Referring to FIG. 4, when the upper mold 130 is continuously descended, the pressing portions 134 of the upper mold 130 may downwardly press the two edge portions of the upper surface of the glass G until the two edge portions of the glass G may make contact with (e.g., physically contact) the forming portion 115 of the lower mold 110. For example, the downwardly rounded portions having a curvature corresponding to that of the forming portion 115 may be formed at the two edge portions of the glass G.

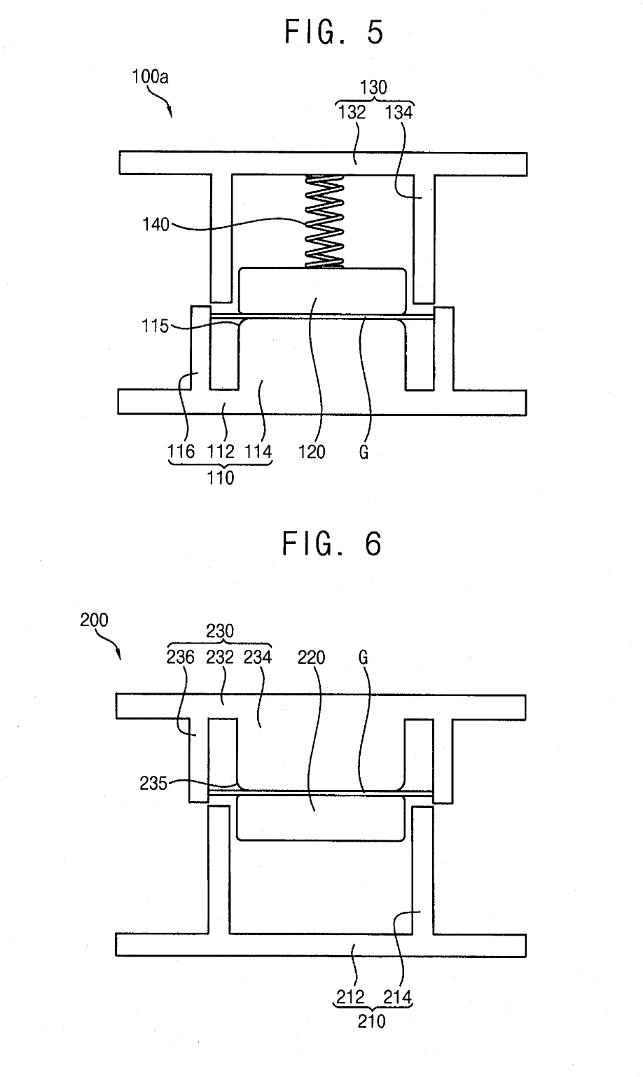

FIG. 5 is a cross-sectional view of an apparatus for forming a glass in accordance with other example embodiments.

An apparatus 100a for forming a glass in accordance with this example embodiment may include elements substantially the same as those of the apparatus 100 in FIG. 1 except for further including a spring. The same reference numerals may refer to the same elements and any further illustrations and/or descriptions with respect to those same elements may be omitted herein for brevity.

Referring to FIG. 5, the apparatus 100a of this example embodiment may further include a spring 140. The spring 140 may be connected between the fixing mold 120 and the upper mold 130. In example embodiments, the spring 140 may have a lower end connected to an upper surface of the fixing mold 120, and an upper end connected to the lower surface of the upper block 132 of the upper mold 130.

In example embodiments, the spring 140 may resiliently support the fixing mold 120 in the downward direction (e.g., toward the lower mold 110). The fixing mold 120 may support (e.g., firmly support) the central portion of the upper surface of glass G using a strong force provided by the spring 140 and/or gravity.

FIG. 6 is a cross-sectional view an apparatus for forming a glass in accordance with still other example embodiments.

Referring to FIG. 6, an apparatus 200 for forming a glass in accordance with this example embodiment may include a lower mold 210, a fixing mold 220 and an upper mold 230.

The lower mold 210 may upwardly press the two edge portions of the glass G to form upwardly rounded portions at the two edge portions of the glass G. In example embodiments, the lower mold 210 may include a lower block 212 and a pair of pressing portions 214.

The pressing portions 214 may be on (e.g., may vertically extend from) an upper surface of the lower block 212. The pressing portions 214 may upwardly press the two edge portions of the upper surface of the glass G to form the upwardly rounded portions at the two edge portions of the glass G.

The fixing mold 220 may be configured to support the central portion of the lower surface of the glass G. For example, the fixing mold 220 may be arranged between the pressing portions 214 of the lower mold 210. The fixing mold 220 may support (e.g., firmly support) the central portion of the glass G, together with the upper mold 230, to prevent deflection of the glass G (or reduce deflection of the glass G). For example, the fixing mold 220 may reduce the amount of undesirable bending of the glass G prior to the glass G being pressed by the pressing portions 214.

In example embodiments, the fixing mold 220 may not be connected to the lower mold 210 (e.g., the fixing mold 220 and the lower mold 210 may be separate or disconnected from one another). Alternatively, the fixing mold 220 may be connected to the lower mold 210.

The upper mold 230 may include an upper block 232, a supporting portion 234 and a pair of guiding portions 236. The supporting portion 234 may be on a central portion (e.g., an inner or interior portion) of an upper surface of the upper block 232 to support the central portion of the upper surface of the glass G. The fixing mold 220 and the supporting portion 234 may support (e.g., firmly support) the central portion of the glass G to prevent deflection of the glass G (or reduce deflection of the glass G). In example embodiments, the supporting portion 234 may have an area that is substantially the same as that of the fixing mold 220. The two edge portions of the glass G may protrude from two side surfaces of the supporting portion 234 and two side surfaces of the fixing mold 220.

The guiding portions 236 may be on (e.g., vertically extend from) a lower surface of the upper block 232 at two sides of the supporting portion 234 to guide the two edge portions of the glass G. Each pressing portion 214 may be positioned (or located) between the guiding portion 236 and the fixing mold 220. In some embodiments, when the pressing portions 214 ascend, the pressing portions 214 may upwardly press the two edge portions of the lower surface of the glass G.

In example embodiments, the upper mold 230 may have a forming portion 235 formed on lower ends of the two side surfaces of the supporting portion 234. The forming portion 235 may make contact with (e.g., physically contact) the two edge portions of the glass G when the glass G is upwardly pressed by the pressing portions 214 to form upwardly rounded portions at the two edge portions of the glass G. For example, the forming portion 235 may have a curvature corresponding to a curvature formed at the upwardly rounded portion of the glass G. In some embodiments, the curvature of the forming portion 235 is determined (or set) in accordance with a design curvature of the upwardly rounded portion of the glass G (e.g., a desired curvature to be formed in the glass G).

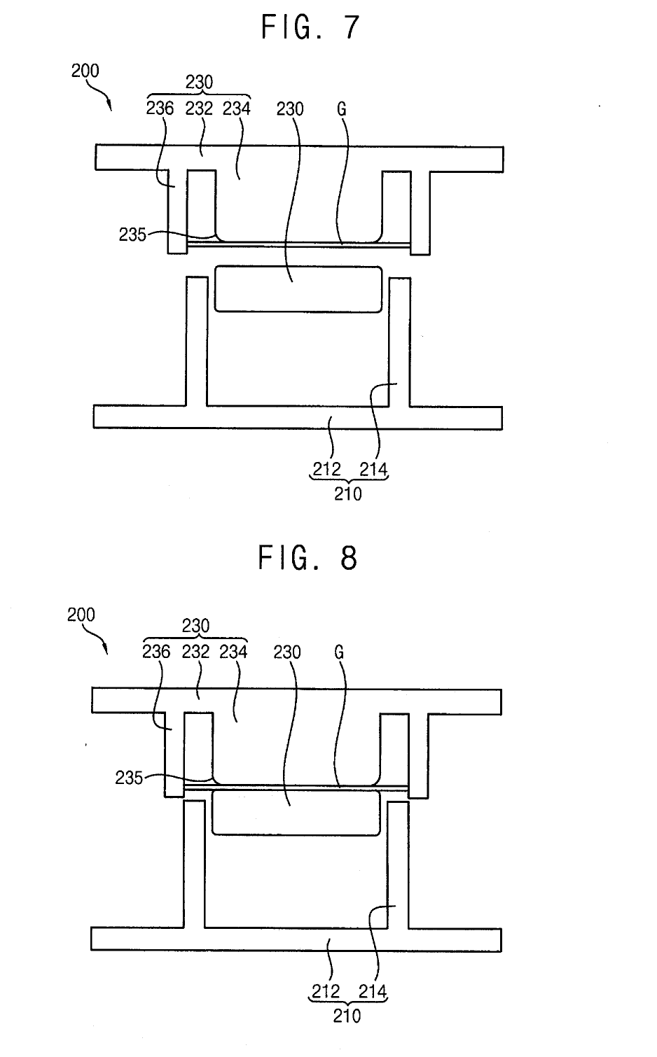

FIGS. 7 to 9 are cross-sectional views illustrating a process of forming the glass using the apparatus in FIG. 6.

Referring to FIG. 7, in a high temperature chamber, the glass G may be placed on the upper surface of the fixing mold 220. The two edge portions of the glass G may protrude from the two side surfaces of the fixing mold 220.

Referring to FIG. 8, the upper mold 230 may be descended toward the glass G to fix the central portion of the upper surface of the glass G using the supporting portion 234. In example embodiments, the area of the fixing mold 220 may be substantially the same as that of the supporting portion 234 so that the two edge portions of the glass G may protrude from the two side surfaces of the supporting portion 234 and the two side surfaces of the fixing mold 220. The pressing portions 214 may make contact with (e.g., physically contact) the two edge portions of the lower surface of the glass G.

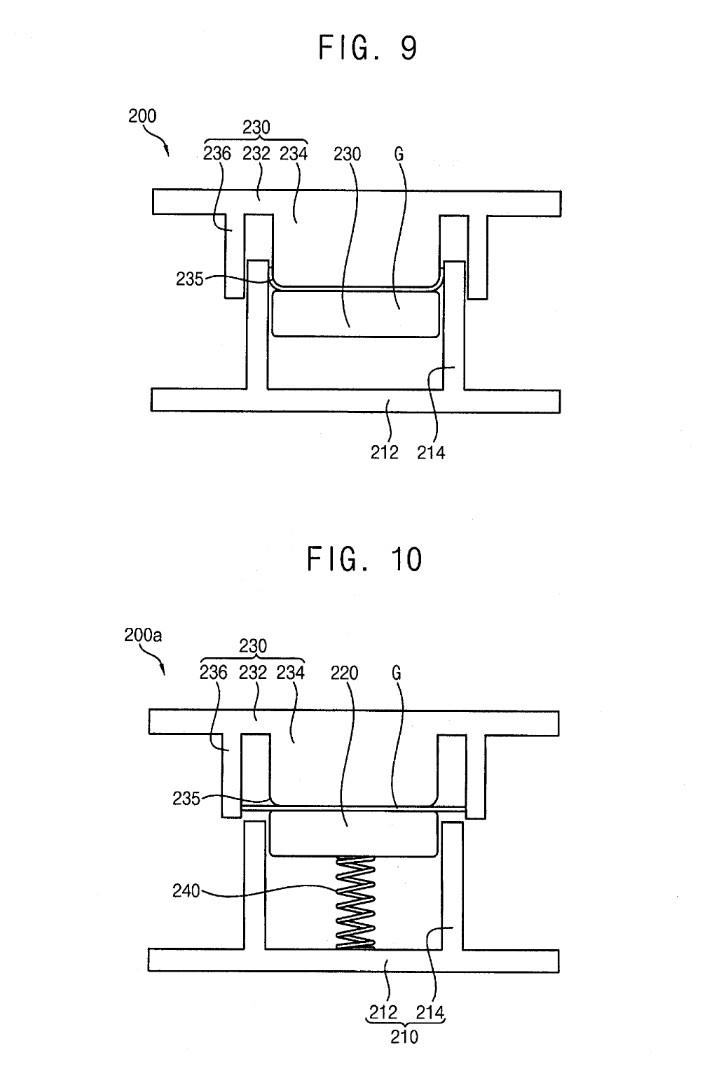

Referring to FIG. 9, when the upper mold 230 is continuously descended (or the pressing portions 214 are continuously ascended), the pressing portions 214 of the lower mold 210 may upwardly press the two edge portions of the lower surface of the glass G until the two edge portions of the glass G may make contact with (e.g., physically contact) the forming portion 235 of the upper mold 230. For example, the upwardly rounded portions having a curvature corresponding to that of the forming portion 235 may be formed at the two edge portions of the glass G.

FIG. 10 is a cross-sectional view of an apparatus for forming a glass in accordance with still other example embodiments.

An apparatus 200a for forming a glass in accordance with this example embodiment may include elements substantially the same as those of the apparatus 200 in FIG. 6 except for further including a spring. The same reference numerals may refer to the same elements and any further illustrations and/or descriptions with respect to those same elements may be omitted herein for brevity.

Referring to FIG. 10, the apparatus 200a of this example embodiment may further include a spring 240. The spring 240 may be connected between the fixing mold 220 and the lower mold 210. In example embodiments, the spring 240 may have a lower end connected to an upper surface of the fixing mold 220, and an upper end connected to the lower surface of the lower block 212 of the lower mold 210.

In example embodiments, the spring 240 may resiliently support the fixing mold 220 in the upward direction (e.g., toward the upper mold 230). The fixing mold 220 may support (e.g., firmly support) the central portion of the upper surface of glass G using a strong force provided by the spring 240.

According to example embodiments of the present disclosure, the fixing mold may firmly support the glass so that the glass may not be deflected (or to reduce deflection of the glass). A rounded portion having a desired shape may be formed at two edge portions of the glass.

The foregoing is illustrative of embodiments of the subject matter disclosed and is not to be construed as limiting thereof. Although a few embodiments have been described, those skilled in the art will readily appreciate that many modifications are possible in the disclosed embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of various embodiments and the present invention is not to be construed as being limited to the specific embodiments disclosed, and that modifications to the disclosed embodiments, as well as other embodiments, are intended to be included within the scope of the appended claims, and equivalents thereof.

What is claimed is:

1. An apparatus for forming a glass, the apparatus comprising:
a lower mold configured to support a central portion of a lower surface of the glass;
a fixing mold configured to support a central portion of an upper surface of the glass; and
an upper mold configured to press two edge portions of the upper surface of the glass to form rounded portions at the two edge portions of the glass.

2. The apparatus of claim 1, wherein the lower mold comprises:
a lower block; and
a supporting portion on an upper surface of the lower block, the supporting portion being configured to support the central portion of the lower surface of the glass.

3. The apparatus of claim 2, wherein the supporting portion has a forming portion at upper ends of two side surfaces of the supporting portion, and the forming portion has a curvature corresponding to a curvature of the rounded portions to be formed in the glass.

4. The apparatus of claim 2, wherein the lower mold further comprises a guiding portion on an upper surface of the lower block at two sides of the supporting portion, the guiding portion being configured to guide the two edge portions of the glass.

5. The apparatus of claim 1, wherein the upper mold comprises:
an upper block; and
pressing portions on a lower surface of the upper block to press the two edge portions of the glass.

6. The apparatus of claim 1, further comprising a spring resiliently connected between the fixing mold and the upper mold.

7. An apparatus for forming a glass, the apparatus comprising:
a lower mold configured to press two edge portions of a lower surface of the glass to form rounded portions at the two edge portions of the glass;
a fixing mold configured to support a central portion of the lower surface of the glass; and
an upper mold configured to support a central portion of an upper surface of the glass.

8. The apparatus of claim 7, wherein the lower mold comprises:
a lower block; and
pressing portions on an upper surface of the lower block to press the two edge portions of the lower surface of the glass.

9. The apparatus of claim 7, wherein the upper mold comprises:
an upper block; and
a supporting portion on a lower surface of the upper block, the supporting portion being configured to support the central portion of the upper surface of the glass.

10. The apparatus of claim 9, wherein the supporting portion has a forming portion at lower ends of two side surfaces of the supporting portion, and the forming portion has a curvature corresponding to a curvature of the rounded portions to be formed in the glass.

11. The apparatus of claim 9, wherein the upper mold further comprises a guiding portion on a lower surface of the upper block at two sides of the supporting portion, the guiding portion being configured to guide the two edge portions of the glass.

12. The apparatus of claim 7, further comprising a spring resiliently connected between the fixing mold and the lower mold.

13. A method of forming a glass, the method comprising:
fixing the glass to a first mold;
fixing a fixing mold to the glass; and
pressing two edge portions of the glass with a second mold to form rounded portions at the two edge portions of the glass.

14. The method of claim 13, wherein:
the first mold is a lower mold,
the fixing of the glass to the first mold comprises placing the glass on the lower mold,
the fixing of the fixing mold to the glass comprises placing the fixing mold on a central portion of an upper surface of the glass,
the second mold is an upper mold, and
the pressing of the two edge portions of the glass comprises pressing the upper surface of the two edge portions of the glass.

15. The method of claim 14, wherein the lower mold comprises:
a lower block; and
a supporting portion on an upper surface of the lower block, the supporting portion being configured to support a central portion of a lower surface of the glass.

16. The method of claim 15, wherein the supporting portion has a forming portion at upper ends of two side surfaces of the supporting portion, and the forming portion has a curvature corresponding to a curvature of the rounded portions to be formed in the glass.

17. The method of claim 15, wherein the lower mold further comprises a guiding portion on an upper surface of the lower block at two sides of the supporting portion, the guiding portion being configured to guide the two edge portions of the glass.

18. The method of claim 13, wherein:
the first mold is an upper mold,
the fixing of the fixing mold to the glass comprises placing the glass on an upper surface of the fixing mold,
the second mold is a lower mold, and
the pressing of the two edge portions of the glass comprises pressing a lower surface of the two edge portions of the glass.

19. The method of claim 18, wherein the upper mold comprises:
an upper block; and
a supporting portion on a lower surface of the upper block, the supporting portion being configured to support a central portion of an upper surface of the glass.

20. The method of claim 19, wherein the upper mold further comprises a guiding portion on a lower surface of the upper block at two sides of the supporting portion, the guiding portion being configured to guide the two edge portions of the glass.
